(19) United States
(12) Patent Application Publication
(10) Pub. No.: US 2016/0096418 A1
(43) Pub. Date: Apr. 7, 2016

(54) STIFFENERS FOR CAST LIGHT-METAL DOOR HEADERS

(71) Applicant: GM GLOBAL TECHNOLOGY OPERATIONS LLC, Detroit, MI (US)

(72) Inventors: Jon T. Carter, Farmington, MI (US); Anil K. SACHDEV, Rochester Hills, MI (US)

(21) Appl. No.: 14/507,528

(22) Filed: Oct. 6, 2014

(51) Int. Cl. B60J 5/04; B60J 10/08; B60J 5/00

(52) U.S. Cl. CPC B60J 5/042; B60J 5/00; B60J 10/08; B60J 5/0463

(57) ABSTRACT

Stiffeners are disclosed which can be added to the header section of cast light-metal door panels. The header section casting can be designed for manufacturability, and to meet nominal lateral stiffness specifications while making effective use of material. The stiffeners can be cast in place in the header or attached to the header section after casting via snap-fit features, adhesive or both. The stiffeners can themselves be made of a light-weight metal such as aluminum, and can be produced by roll forming, stamping or extrusion. By effectively yielding a closed-section door header shape, the stiffeners provide maximum incremental bending stiffness in the header while adding a minimum amount of incremental material and mass.

### GOVERNMENT CONTRACT

This invention was made with U.S. Government support under Agreement No. DE-EE0005753 awarded by the U.S. Department of Energy. The U.S. Government may have certain rights in this invention.

### BACKGROUND OF THE INVENTION

1. Field of the Invention

This invention relates generally to enhanced stiffness of an automobile door header and, more particularly, to stiffeners which can be added to cast light-metal door headers, where the headers are part of door inner panels and have open sections by virtue of being cast, and the stiffeners effectively provide a closed section header with greater bending stiffness and minimal additional weight.

2. Discussion of the Related Art

Automobile manufacturers are increasingly turning to castings of low density metals such as magnesium, taking the place of parts which were traditionally fabricated from stamped steel. These light-metal castings have found many applications in vehicles, including door inner panels. A cast light-metal door inner panel can replace many stamped steel parts, eliminate the need for multiple welding and other fabrication steps, and reduce door weight. One downside of cast door inner panels is that closed cross-sections cannot be produced by die casting, the preferred method to make thin wall sections. A closed section is particularly desirable in the door header area, where the thickness of the door is lowest.

Door headers are typically required to meet a prescribed lateral stiffness specification, where an outboard load is applied at the mid-span of the header (above the center of the window) and the deflection cannot exceed a certain value. One approach to meeting the header lateral stiffness specification with cast door panels, while remaining within the cross-sectional area constraints of the header, is to make elements of the header section thicker. However, this approach is sub-optimal, because in an open section most of the added material is fairly close to the neutral axis of bending, and is therefore not very effective at increasing the bending stiffness.

Furthermore, with automobile manufacturers leveraging vehicle platforms globally, a particular vehicle design may be sold in markets with different specifications for door header lateral stiffness. In such cases, a door header casting which is designed to meet the most stringent lateral stiffness specification will be overdesigned for markets with less stringent specifications, and vice versa.

### SUMMARY OF THE INVENTION

In accordance with the teachings of the present invention, stiffeners are disclosed which can be added to the header section of cast light-metal door panels. The header section casting can be designed for manufacturability, and to meet nominal lateral stiffness specifications while making effective use of material. The stiffeners can be cast in place in the header or attached to the header section after casting via snap-fit features, adhesive or both. The stiffeners can themselves be made of a light-weight metal such as aluminum, and can be produced by roll forming, stamping or extrusion. By effectively yielding a closed-section door header shape, the stiffeners provide maximum incremental bending stiffness in the header while adding a minimum amount of incremental material and mass. Furthermore, the stiffeners can be applied to vehicles sold in markets with stringent header stiffness specifications, while other vehicles with the same base header casting can be sold in less stringent markets without the stiffeners.

Additional features of the present invention will become apparent from the following description and appended claims, taken in conjunction with the accompanying drawings.

### BRIEF DESCRIPTION OF THE DRAWINGS

FIG. 1 is an illustration of a vehicle door showing the header area which is subject to stiffness specification;

FIG. 2 is an illustration of a traditional stamped steel door header cross section and associated trim;

FIG. 3 is an illustration of a cast door inner panel showing the header region and other regions;

FIG. 4 is an illustration of a door header cross section and associated trim, where the door header is part of the cast door inner panel of FIG. 3;

FIG. 5 is an illustration of a cast door header cross section with a first embodiment of a stiffener;

FIG. 6 is an illustration of a cast door header cross section with a second embodiment of a stiffener;

FIG. 7 is an illustration of a cast door header cross section with a third embodiment of a stiffener;

FIG. 8 is an illustration of a cast door header cross section with a fourth embodiment of a stiffener; and

FIG. 9 is an illustration of a cast door header cross section with a fifth embodiment of a stiffener.

### DETAILED DESCRIPTION OF THE EMBODIMENTS

The following discussion of the embodiments of the invention directed to stiffeners for cast light-metal door headers is merely exemplary in nature, and is in no way intended to limit the invention or its applications or uses.

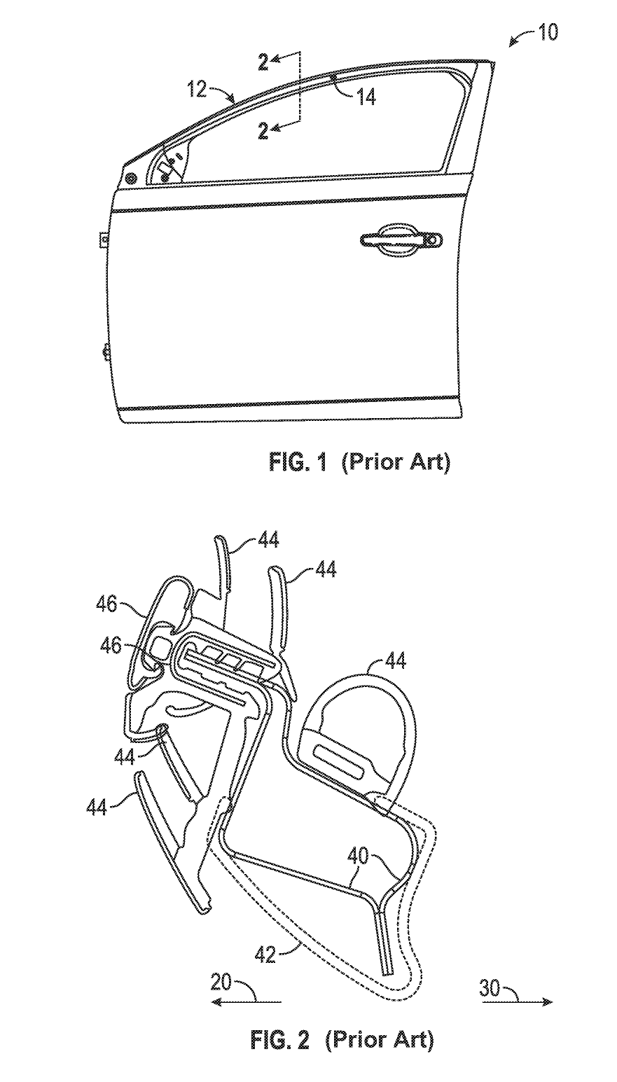

FIG. 1 is an illustration of a vehicle door 10, where the door 10 is a left-side door viewed from the left outside of the vehicle. The door 10 includes a header 12, which is the area above the window of the door 10. The header 12 has the narrowest cross-section of any part of the door 10. Furthermore, the header 12 is subject to a lateral stiffness specification, which may vary from one global region to another. For example, in a well-developed region of the world with high-speed road infrastructure, the door header 12 may be required to exhibit a lateral deflection of less than three millimeters (mm) under application of a lateral load of 150 Newtons (N) applied at a mid-span point 14 on the header. In other regions of the world, the header stiffness specification may not be as stringent.

FIG. 2 is a cross-sectional illustration of a traditional door header and associated trim. In FIG. 2, the outboard direction is represented by arrow 20, while the inboard direction is represented by arrow 30. The header cross-section includes a stamped steel header 40, a plastic inner trim piece 42, and various rubber seals 44. The header cross-section also includes metal clips 46 for holding the exterior trim and seal parts onto the stamped steel header 40.

It can be seen in FIG. 2 that the stamped steel header 40 provides the majority of the structural rigidity to the door header area, as the other components are either rubber or plastic, or are very thin-section metal. It can also be seen that the cross-section of the stamped steel header 40 is designed for maximum lateral bending stiffness. That is, the stamped steel header 40 has a closed-section shape, and the material has been placed as far as possible to the lateral extremes of the cross-section while remaining within packaging constraints. These design features enable the stamped steel header 40 to meet the lateral bending stiffness specification.

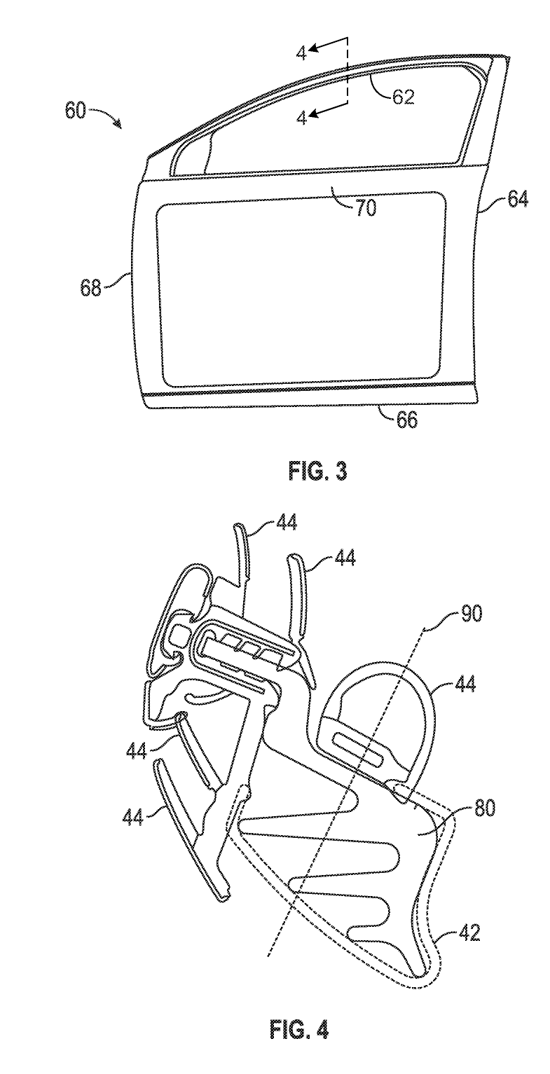

Vehicle manufacturers are constantly striving to reduce vehicle assembly time, reduce part-to-part variability and reduce vehicle mass. For these and other reasons, some vehicles now use single-piece light-metal castings for door inner panels. Magnesium is a preferred material for such castings; aluminum may also be used. FIG. 3 is an illustration of a cast door inner panel 60 which may be used in place of numerous stamped parts in a vehicle. The cast inner door panel 60 includes a header region 62, a latch region 64, a rocker region 66, a hinge region 68 and a beltline region 70. Other components which would be added to the cast door inner panel 60 to produce a complete door assembly—such as an anti-intrusion beam, a window-lift mechanism and a glass guide—are omitted for simplicity.

The cast door inner panel 60 offers several advantages over a stamped, fabricated design, as discussed previously. However, it is still required to meet header lateral stiffness specifications and this has sometimes been difficult to achieve—due to the lower stiffness of light-metals than steel, and the inherent limitation of die castings to open cross sections. It is generally not feasible to simply add more material to the header region 62 in order to meet bending stiffness requirements—because cross-sectional elements which are excessively thick cannot be cast with good quality. Furthermore, it would be decidedly suboptimal to produce the cast door inner panel 60 without the header region 62, and then have to fabricate and attach a separate stamped steel header part. Thus, the challenge becomes how to meet the header lateral stiffness specification with the light-metal cast door inner panel 60.

FIG. 4 is a cross-sectional illustration of a door header and associated trim, where the door header is part of the cast door inner panel 60 of FIG. 3. A cast header section 80, which is part of the cast door inner panel 60, replaces the stamped steel header 40 shown previously. It can be seen in FIG. 4 that the cast header section 80 fits within the same packaging space as the stamped steel header 40, and can be used with the same trim pieces—namely, the plastic inner trim piece 42, the rubber seals 44 and the metal clips 46. The cast header section 80 is one embodiment of a header cross-sectional shape when incorporated in the cast door inner panel 60. Other shapes are shown in later figures and discussed below. The cast header section 80 is, by necessity, an open section design. Analysis of the cast header section 80 indicates that a neutral axis of bending 90 is located as shown in FIG. 4. In order to increase the lateral bending stiffness of the cast header section 80, it would be desirable to add material as far from the neutral axis 90 as possible, while providing a closed cross-sectional shape.

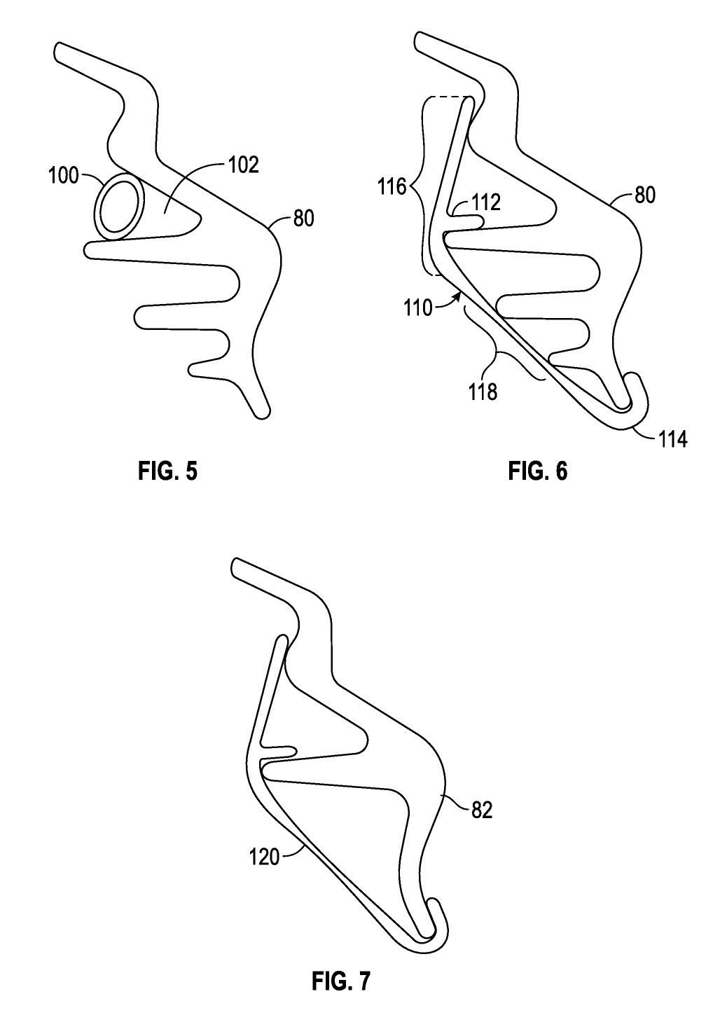

FIG. 5 is a cross-sectional illustration of the cast header section 80 with a first embodiment of stiffness enhancement. A stiffener 100 is added to the cast header section 80 in order to increase the area moment of inertia, or resistance to bending, of the cross section. The stiffener 100 has a tube shape, which could either be roll-formed or extruded. The stiffener 100 is preferably made of aluminum, but could be any other metal or even a composite material. The stiffener 100 can be pressed into position in a V-shaped cavity 102 of the cast header section 80, and permanently bonded with an adhesive. The stiffener 100 could also be formed into a shape matching the V-shaped cavity 102 and cast in place during the casting of the cast door inner panel 60, where the stiffener 100 would serve as part of the casting die for this portion of the cast header section 80. The stiffener 100 embodies its own closed section, and also forms a closed section with the cast header section 80 around the V-shaped cavity 102. The stiffener 100 also provides a considerable amount of material at a near-maximum distance from the neutral axis 90, while still fitting within the packaging constraints. For these reasons, the stiffener 100 significantly enhances the lateral bending stiffness of the cast header section 80.

FIG. 6 is an illustration of a cast door header cross section with a second embodiment of stiffness enhancement. A stiffener 110 has a generally channel-like shape which fits over the open portion of the cast header section 80. The stiffener 110 includes features 112 and 114 which enable the stiffener 110 to be snap-fit in place on the cast header section 80. The feature 112 is a web extending from the body of the stiffener 110 inwardly toward the cast header section 80, where the feature 112 engages with an opposing web on the cast header section 80. The feature 114 is a curved edge of the stiffener 110 which wraps around a free edge of the cast header section 80, as shown.

An adhesive could also be applied to the contact locations on the stiffener 110 and the cast header section 80 just before the stiffener 110 is snap-fit into place, where the snap-fit allows the cast door inner panel 60 to immediately continue on to the next step of the door assembly process while the adhesive cures, and the cured adhesive increases the strength of the attachment between the stiffener 110 and the cast header section 80. The stiffener 110, while itself being an open channel section, forms a closed section with the cast header section 80 when assembled. The stiffener 110 also provides a considerable amount of material (in region 116) at a maximum distance from the neutral axis 90, while still fitting within the packaging constraints. Thus, the stiffener 110 significantly enhances the lateral bending stiffness of the cast header section 80. The stiffener 110 can also be made thinner in region 118, close to the neutral axis 90 where the material is less effective at increasing bending stiffness, so as to reduce material cost and weight.

FIG. 7 is an illustration of a cast door header cross section with a third embodiment of stiffness enhancement. A stiffener 120 includes the same design features as the stiffener 110 of FIG. 6 (and may in fact be identical to the stiffener 110), but the stiffener 120 is used with a cast header section 82 which is different than the cast header section 80. In particular, the cast header section 82 eliminates two shorter transverse webs which do little to increase lateral bending stiffness because of their proximity to the neutral axis 90. This illustrates how the stiffener 120 can provide an overall more mass-efficient door header design by eliminating material (in the cast header section 82) which is close to the neutral axis 90 and replacing it with material (in the stiffener 120) which is as far as possible from the neutral axis 90 while still meeting packaging constraints.

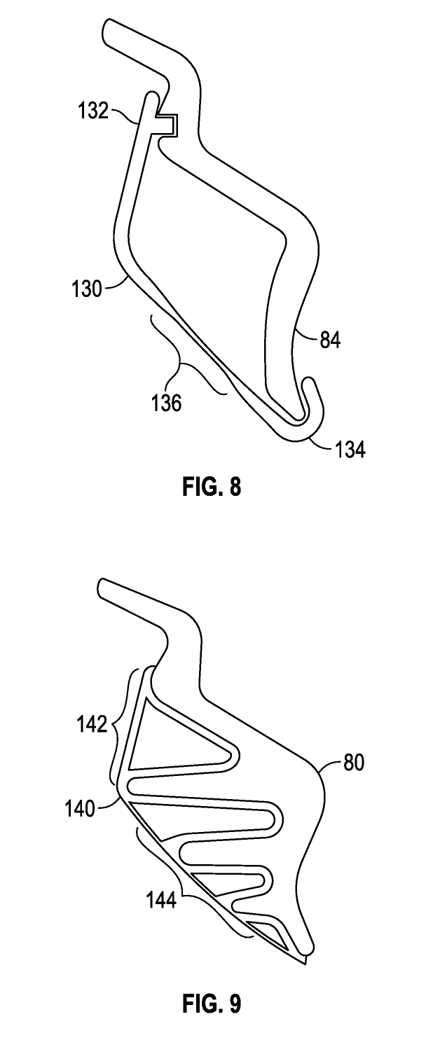

FIG. 8 is an illustration of a cast door header cross section with a fourth embodiment of stiffness enhancement. A stiffener 130 has a generally channel-like shape and includes some of the same design features as the stiffeners 110 and 120, but the stiffener 130 is used with a cast header section 84 which includes no transverse webs. The stiffener 130 includes features 132 and 134 which enable the stiffener 130 to be snap-fit in place on the cast header section 84 while the adhesive cures. The stiffener 130 also features localized material thinning in region 136—close to the neutral axis 90—in order to reduce mass without significantly reducing bending stiffness. The designs of the stiffener 130 and the cast header section 84 illustrate how a very mass-efficient cast door header design can be achieved by emulating the optimal shape of the stamped steel header 40 discussed previously.

In a preferred embodiment, the stiffeners 110/120/130 are aluminum extrusions; however, other materials and processes may be used. For example, with some design modifications, the stiffeners 110/120/130 could be stamped and formed from aluminum or another metal. The stiffeners 110/120/130 could also be composed of other materials, such as a carbon-fiber composite, where virtually any section shape could be formed.

FIG. 9 is an illustration of a cast door header cross section with a fifth embodiment of stiffness enhancement. In FIG. 9, the cast header section 80 shown in several previous figures is again used. A stiffener 140, preferably extruded aluminum, has a shape which allows it to be used as a die for the casting of the cast header section 80 of the cast door inner panel 60. Thus, the stiffener 140 is cast in place and becomes integral to the cast header section 80. This arrangement not only simplifies the casting of the cast header section 80, but provides significant incremental bending stiffness. The stiffener 140 can be designed to optimize material usage, with greater thickness in a region 142 (furthest from the neutral axis 90) and lesser thickness in a region 144 (near the neutral axis 90).

Using the stiffeners disclosed herein, and other derivations which can be envisioned, cast light-metal door inner panels can be provided with enhanced lateral bending stiffness in the header area. By tailoring the design of the stiffeners, including forming a closed section with the cast header, significant additional lateral bending stiffness of the header can be achieved with minimal added mass. Furthermore, the stiffeners can be designed to meet the bending stiffness specifications of particular global vehicle markets without changing the base casting design, and omitted entirely for markets where incremental stiffness is not required.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A door header for a vehicle, said header comprising:
a cast header section, said cast header section being part of a cast light-metal door inner panel, where the cast header section has an open cross-sectional shape defining a channel which is oriented with a concave surface facing toward an exterior of the vehicle, and the light-metal is either magnesium or aluminum; and
a stiffener, said stiffener being attached to the cast header section so as to create a closed cross-sectional shape to provide additional bending stiffness to the cast header section.

2. The door header of claim 1 wherein the stiffener is an aluminum extrusion which has a cross-sectional shape defining a channel, where the stiffener is positioned outboard of the cast header section and is oriented with a concave surface facing toward an interior of the vehicle and mating with the cast header section to form the closed cross-sectional shape.

3. The door header of claim 2 wherein the stiffener is attached to the cast header section via a snap-fit engagement of the stiffener with geometric features of the cast header section, and where an adhesive is applied to contacting surfaces of the stiffener and the cast header section, and the adhesive cures while the door inner panel is further processed in assembly of the vehicle.

4. The door header of claim 3 wherein the snap-fit engagement includes a curved edge of the stiffener which fits over a free edge of the cast header section, and a web on the stiffener extending into the closed cross-sectional shape and engaging with an opposing web on the cast header section.

5. The door header of claim 3 wherein the stiffener is extruded in a cross-sectional shape that is designed to optimize combined area moment of inertia when attached to the cast header section relative to mass, where a wall of the stiffener is thicker in a region which is furthest from a neutral axis of bending of the cast header section, and the wall of the stiffener is thinner in a region which is nearest the neutral axis of bending of the cast header section.

6. The door header of claim 3 wherein the cast header section includes a plurality of webs extending into the closed cross-sectional shape, and the stiffener is designed with a cross-sectional shape which fits over and contacts each of the plurality of webs.

7. The door header of claim 1 wherein the stiffener is an aluminum tube which is pressed into a V-shaped cavity in an outboard-facing side of the cast header section such that the tube and the V-shaped cavity form the closed cross-sectional shape.

8. The door header of claim 7 wherein an adhesive is applied to contacting surfaces of the tube and the V-shaped cavity, and the adhesive cures while the door inner panel is further processed in assembly of the vehicle.

9. The door header of claim 1 wherein the stiffener is an aluminum tube which is formed into a V-shaped cross section and cast in place in an outboard-facing side of the cast header section, where the tube serves as a casting die wall for a portion of the cast header section which the tube contacts.

10. The door header of claim 1 wherein the stiffener is an aluminum extrusion which is formed to include a plurality of inverted V-shaped cross-sectional features and cast in place in an outboard-facing side of the cast header section, such that the cast header section includes a plurality of webs separated by V-shaped cavities, and where the stiffener serves as a casting die wall for a portion of the cast header section which the stiffener contacts.

11. A door inner panel assembly for a vehicle, said assembly comprising:
a cast magnesium door inner panel, said cast magnesium door inner panel including a header region, a latch region, a rocker region, a hinge region and a beltline region, where the header region has an open cross-sectional shape defining a channel which is oriented with a concave surface facing toward an exterior of the vehicle;
an aluminum stiffener, said stiffener being attached to the header region of the door inner panel so as to create a closed cross-sectional shape to provide additional bending stiffness to the header region.

12. The assembly of claim 11 wherein the stiffener is an aluminum extrusion which has a cross-sectional shape defining a channel, where the stiffener is positioned outboard of the header region and is oriented with a concave surface facing toward an interior of the vehicle and mating with the header region to form the closed cross-sectional shape.

13. The assembly of claim 12 wherein the stiffener is attached to the header region via a snap-fit engagement of the stiffener with geometric features of the header region, and where an adhesive is applied to contacting surfaces of the stiffener and the header region and the adhesive cures while the door inner panel assembly is further processed in assembly of the vehicle, and where the snap-fit engagement includes a curved edge of the stiffener which fits over a free edge of the header region and a web on the stiffener extending into the closed cross-sectional shape and engaging with an opposing web on the header region.

14. The assembly of claim 12 wherein the stiffener is extruded in a cross-sectional shape that is designed to optimize combined area moment of inertia when attached to the header region relative to mass, where a wall of the stiffener is thicker in a location which is furthest from a neutral axis of bending of the header region, and the wall of the stiffener is thinner in a location which is nearest the neutral axis of bending of the header region.

15. The assembly of claim 11 wherein the stiffener is an aluminum tube which is pressed into a V-shaped cavity in an outboard-facing side of the header region such that the tube and the V-shaped cavity form the closed cross-sectional shape, and where an adhesive is applied to contacting surfaces of the tube and the V-shaped cavity, and the adhesive cures while the door inner panel is further processed in assembly of the vehicle.

16. The assembly of claim 11 wherein the stiffener is an aluminum extrusion which is formed to include a plurality of inverted V-shaped cross-sectional features and cast in place in an outboard-facing side of the header region, such that the header region includes a plurality of webs separated by V-shaped cavities, and where the stiffener serves as a casting die wall for a portion of the header region which the stiffener contacts.

17. A method for assembling a door inner panel for a vehicle, said method comprising:
providing a cast light-metal door inner panel, said door inner panel including a cast header section, where the cast header section has an open cross-sectional shape defining a channel which is oriented with a concave surface facing toward an exterior of the vehicle, and the light-metal is either magnesium or aluminum;
providing a stiffener which is designed to be attached to the cast header section of the door inner panel so as to create a closed cross-sectional shape to increase a bending stiffness of the cast header section;
determining if the cast header section requires additional lateral bending stiffness in order to meet a lateral bending stiffness specification for a market in which the vehicle is to be sold; and
attaching the stiffener to the cast header section if it is determined that the cast header section requires additional lateral bending stiffness.

18. The method of claim 17 wherein the stiffener is an aluminum extrusion which has a cross-sectional shape defining a channel, where the stiffener is positioned outboard of the cast header section and is oriented with a concave surface facing toward an interior of the vehicle and mating with the cast header section to form the closed cross-sectional shape.

19. The method of claim 18 wherein the stiffener is attached to the cast header section via a snap-fit engagement of the stiffener with geometric features of the cast header section, and where an adhesive is applied to contacting surfaces of the stiffener and the cast header section and the adhesive cures while the door inner panel assembly is further processed in assembly of the vehicle, and where the snap-fit engagement includes a curved edge of the stiffener which fits over a free edge of the cast header section and a web on the stiffener extending into the closed cross-sectional shape and engaging with an opposing web on the cast header section.

20. The method of claim 18 wherein the stiffener is extruded in a cross-sectional shape that is designed to optimize combined area moment of inertia when attached to the cast header section relative to mass, where a wall of the stiffener is thicker in a location which is furthest from a neutral axis of bending of the cast header section, and the wall of the stiffener is thinner in a location which is nearest the neutral axis of bending of the cast header section.
